(19) United States
(12) Patent Application Publication
(10) Pub. No.: US 2017/0191553 A1
(43) Pub. Date: Jul. 6, 2017

(54) POWER STRUT

(71) Applicant: Hi-Lex Controls, Inc., Rochester Hills, MI (US)

(72) Inventors: John Heiberger, Rochester Hills, MI (US); Kevin Koneval, Rochester Hills, MI (US); Fred Eberle, Rochester Hills, MI (US); Favad Shah, Rochester Hills, MI (US); Jeff Kolar, Rochester Hills, MI (US)

(73) Assignee: Hi-Lex Controls, Inc.

(21) Appl. No.: 14/989,247

(22) Filed: Jan. 6, 2016

(51) Int. Cl. F16H 25/20; F16H 25/24; E05F 15/622; B60J 5/10

(52) U.S. Cl. CPC F16H 25/20; B60J 5/106; F16H 25/2418; E05F 15/622; F16H 2025/2087; E05Y 2201/434; E05Y 2201/70; E05Y 2201/702; E05Y 2900/532

(57) ABSTRACT

A power strut for raising and lowering a liftgate of an automotive vehicle includes an outer housing tube carrying a first attachment element for attaching the power strut to a vehicle. A spindle bearing an outer thread is rotatable relative to the outer housing tube via an electric motor. The spindle is axially stationary relative to the outer housing tube. A spindle nut having an inner thread meshing with the outer thread of the spindle is displaceable along the longitudinal axis. A nut tube is rigidly connected to the spindle nut and surrounds the spindle. A second attachment element is located opposite the first attachment element. The first attachment element has a first snap structure that is complementary to a second snap structure formed on the outer housing tube. The first and second snap structures non-rotatably secure the first attachment element to the outer housing tube.

### TECHNICAL FIELD OF THE INVENTION

This application relates to a power actuators and more particularly to a power strut for lifting a pivotal lift gate closing an access opening in a motor vehicle body.

### BACKGROUND

Motor vehicles of the hatchback and van configuration typically include an access opening at the rear of the vehicle body and a lift gate selectively opening and closing the access opening. The lift gate is typically manually operated and specifically requires manual effort to move the gate between open and closed positions. Various attempts have been made to provide power actuation for the lift gate. As with all automotive components, the reduction of costs, weight and spatial dimensions is a continuous concern in view of demand for increasing technology and safety features in vehicles on the one hand and for affordability and lower fuel consumption on the other hand.

### SUMMARY OF THE INVENTION

In one aspect of the present invention, a power strut is described for raising and lowering a liftgate of an automotive vehicle. The power strut includes an outer housing tube having a first end carrying a first attachment element for attaching the power strut to a first vehicle part. A spindle bearing an outer thread is rotatable relative to the outer housing tube via an electric motor. The spindle defines a longitudinal axis of the power strut and is axially stationary relative to the outer housing tube. A spindle nut having an inner thread meshing with the outer thread of the spindle is displaceable along the longitudinal axis relative to the spindle. A nut tube is rigidly connected to the spindle nut and surrounds at least a portion of the spindle. A second attachment element for attaching the power strut to a second vehicle part is located opposite the first attachment element. A compression spring surrounds the nut tube and biases the first and second attachment elements apart from each other. To save machining labor and costs, the compression spring may be an open spring formed of a coiled wire with perpendicularly cut wire ends.

A profile disc in contact with a first end of the compression spring and surrounding the nut tube may have a profile complementary to the first end of the compression spring to compensate for one of the perpendicularly cut wire ends. The profile disc may be rotatable relative to the outer housing tube by torsional forces exerted by the compression spring.

A spring guide tube with a radial end collar in contact with a second end of the compression spring, the spring guide tube extending between the compression spring and the nut tube, wherein the radial collar has a profile complementary to the second end of the compression spring.

If the profile disc is rotatable, the spring guide tube may be secured against rotation relative to the outer housing tube. For example, the spring guide tube may have an internal cross-sectional shape cooperating with an anti-rotation shape formed on the spindle nut the cross-sectional shape and the anti-rotation shape allowing the spindle nut to slide axially along the spring guide tube while maintaining a relative rotational position between the spindle nut and the spring guide tube. Such an internal anti-rotation feature has the benefit that rotational forces do not need to be restrained in the locations of the upper and lower attachments to the vehicle.

The radial end collar of the spring guide tube may have a circumference with a radial annular groove and an O-ring disposed in the annular groove, wherein the O-ring preferably has an outer circumference bearing against an inner surface of the outer housing tube.

The first attachment element may have a first snap structure that is complementary to a second snap structure formed on the outer housing tube. The first and second snap structures non-rotatably secure the first attachment element to the outer housing tube.

The outer housing tube and the first attachment element, at least in the area of the first and second snap structures, may be made of plastic. One of the first and second snap structures may be formed by snap tongues and the other one of the first and second snap structures may be formed by slots so that the snap tongues are snapped into the slots.

An O-ring may be disposed between the first attachment element and the outer housing tube in a radial annular groove formed along an outer circumference of the first attachment element. The O-ring provides a seal against contamination and enhances noise reduction.

The second attachment element may include an end plug rigidly connected to the nut tube by crimping. For example, the end plug may have a cylindrical axial extension with a cylindrical surface having radial voids. The cylindrical axial extension being disposed inside the nut tube, wherein material of the nut tube is displaced radially inward into the voids.

The second attachment element may further include a joint socket with a plastic body, and the end plug may have a serrated axial extension, the serrated axial extension being disposed inside the plastic body of the joint socket and rigidly connected therewith.

The electric motor and a planetary gear box are arranged to translate a rotational output speed of the motor to a rotational drive speed of the spindle, wherein both the electric motor and the planetary gear box are disposed inside the outer housing tube.

An inner housing tube may be telescopically displaceably arranged radially inside the outer housing tube and surrounding the spindle nut, the spindle tube, and at least a portion of a compression spring.

The spring guide tube, the outer housing tube, and the inner housing tube may all be made of plastic. The nut tube is preferably made of metal.

All these features combined provide for a power strut with low manufacturing costs with respect to material and labor. Due to the strategic use of plastic parts, the power strut is lightweight yet durable.

Further details and benefits of the various aspects of the present invention will become apparent from the following description of the accompanying drawings. The drawings are provided purely for illustrative purposes and are not intended to limit the scope of the present invention.

### BRIEF DESCRIPTION OF THE DRAWINGS

In the drawings,

FIG. 1 shows a cross-sectional view of a power strut according to an aspect of the present invention;

FIGS. 2a and 2b show a first detail of the power strut of FIG. 1 in a partially assembled view and a fully assembled view;

FIG. 3 shows a second detail of the power strut of FIG. 1 in a cross-sectional view.

FIGS. 4a, 4b, and 4c show a third detail of the power strut of FIG. 1 in an unassembled view, in a partially assembled view, and in an assembled view; and

FIGS. 5a and 5b show a fourth detail of the power strut of FIG. 1 in an assembled view and a disassembled view.

### DETAILED DESCRIPTION OF THE DRAWINGS

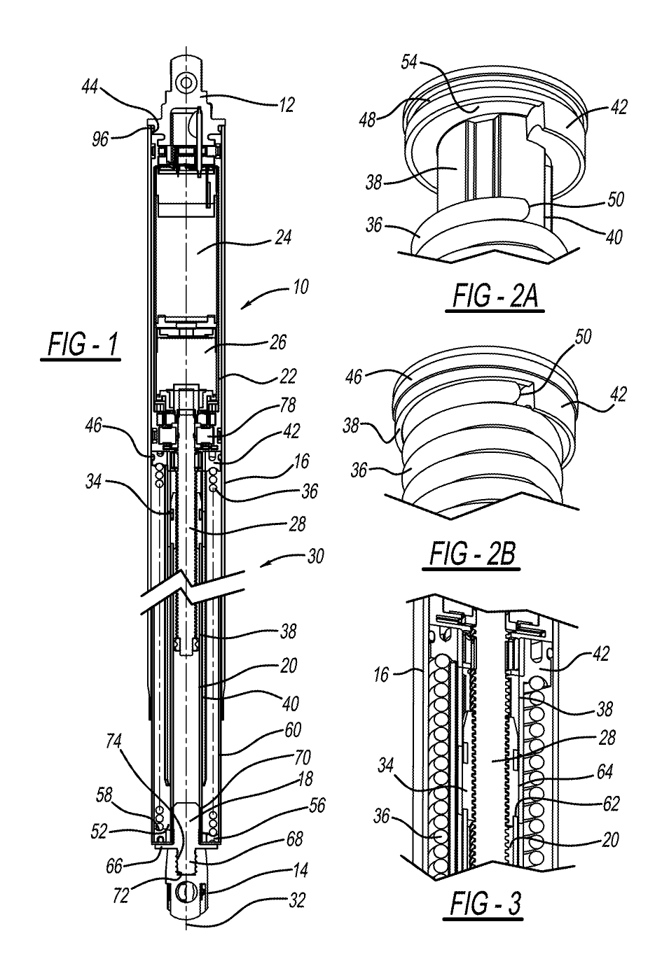

FIG. 1 shows a cross-sectional view of a power strut 10 for operating a liftgate of an automotive vehicle. The power strut 10 of FIG. 1 includes a number of features that all contribute to the general objective of providing an affordable, compact, and light-weight power strut 10 meeting all technical specifications. The individual features are shown in the subsequent drawings and may be implemented independently from one another to provide their specific advantages irrespective of the use of any of the other features.

The power strut 10 of FIG. 1 includes a first joint socket 12 at one end and a second joint 14 socket at the opposite end. The joint sockets 12 and 14 form parts of pivotable mounts, for example ball joints, for installing the power strut 10 between two vehicle parts that perform a relative movement with respect to one another, such as a vehicle frame and a liftgate to be raised and lowered. Thus, while the joint sockets 12 and 14 may be ball sockets, other structures suited for the intended installation are well within the scope of the present invention.

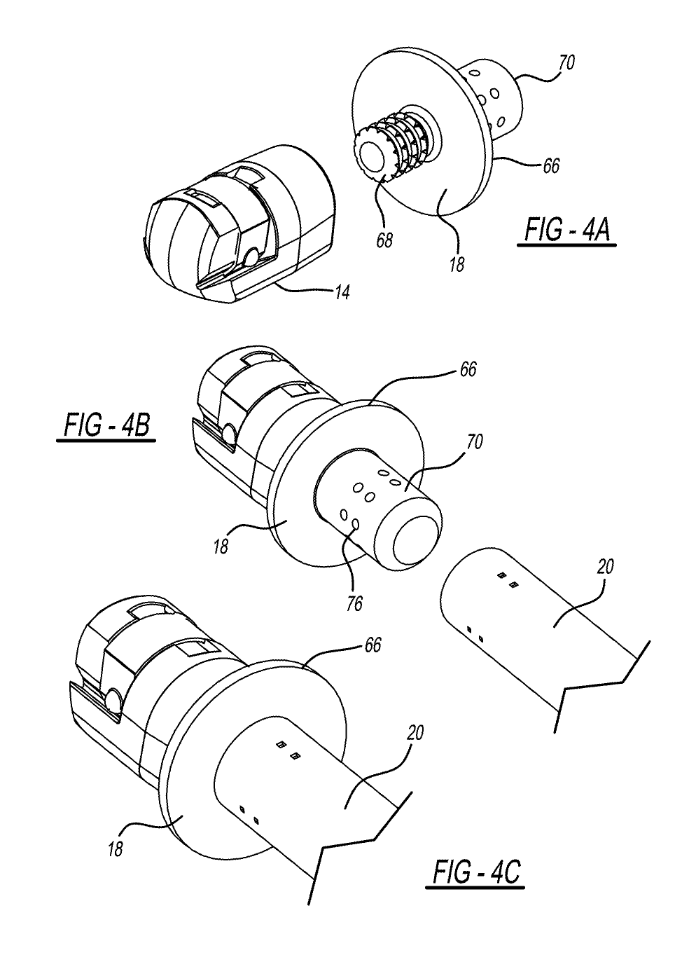

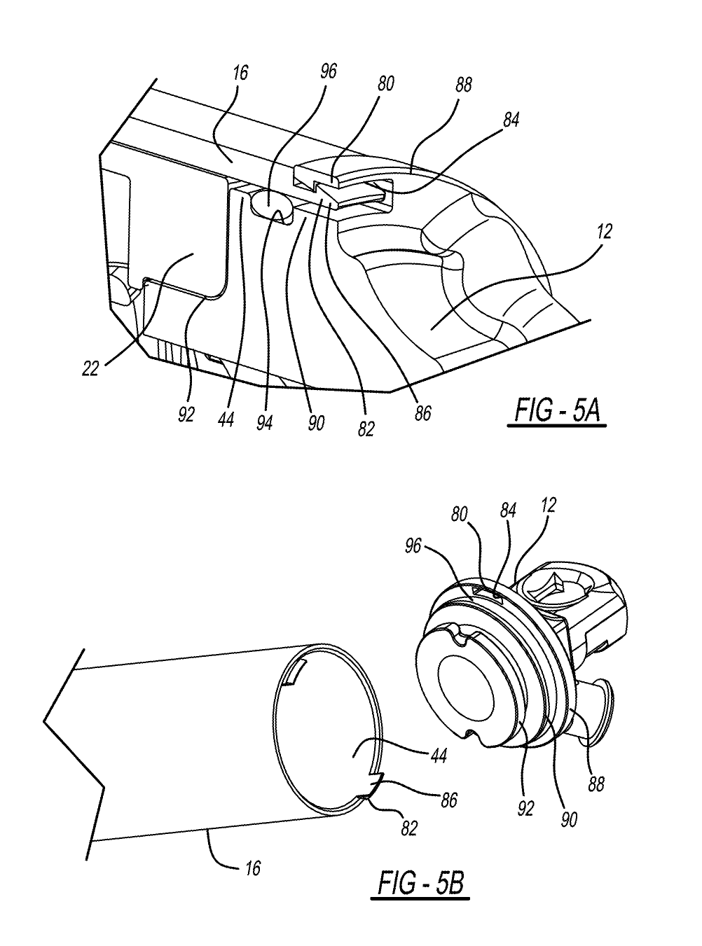

The first joint socket 12 shown at the top of FIG. 1, which will also be called motor-side joint socket 12, is fixedly connected to an outer housing tube 16 as will be explained in more detail in connection with FIGS. 5 a and 5b. The second joint socket 14 at the bottom of FIG. 1, which will be called spring-side joint socket 14, is fixedly attached to an end plug 18 that in turn is fixedly connected to a nut tube 20 as will be explained in more detail in connection with FIGS. 4a through 4c.

Inside the outer housing tube 16 is a tubular drive unit housing 22 accommodating an electric motor 24 and a planetary gearbox assembly 26. A threaded drive spindle 28 extends from the drive unit housing 22 through a bearing 29 into a telescoping portion 30 of the power strut 10 and defines a longitudinal axis 32 along which the telescoping portion 30 expands and contracts.

A spindle nut 34 is molded onto an end of the nut tube 20 opposite the spring-side joint socket 14. Details of the spindle nut 34 are shown in FIG. 3. The spindle nut 34 has an internal thread rotatably engaging the external thread of the drive spindle 28 and translates a rotational movement of the drive spindle 28 into a translatory movement of the spindle nut 34, the nut tube 20 and the spring-side joint socket 14 relative to the motor-side joint socket 12 to extend or contract the power strut 10 along the longitudinal axis 32.

A cylindrical compression spring 36 is arranged around the nut tube 20 and separated therefrom by a spring guide tube 38. The compression spring 36 biases the drive unit housing 22 and the spring-side joint socket 14 apart. The spring guide tube 38 has a tubular portion 40 extending between the compression spring 36 and the nut tube 20 as well as a radial collar 42 abutted by the motor-side end of the compression spring 36. The radial collar 42 has a circumference friction-fitted against an internal circumference 44 of the outer housing tube 16 as shown in more detail in FIGS. 2a and 2b. The friction fit of the radial collar 42 against the outer housing tube 16 is accomplished by an elastomeric O-ring 46 disposed in a radial annular groove 48 extending around the radial collar 42.

As evident from FIGS. 2a and 2b, the compression spring 36 is an open spring formed of a coiled wire with perpendicularly cut wire ends 50 and 52, which means that the end windings are not flattened. Instead, the end windings of the compression spring 36 form an axial step at each of the two ends 50 and 52 of the compression spring 36. The radial collar 42 of the spring guide tube 38 forms a complementary profile 54 compensating for the axial step at the end of the compression spring 36 that rests on the radial collar 42. The profile 54 of the radial collar 42 includes a helical axial groove as seen in FIG. 2a to accommodate the last winding and the wire end 50 of the compression spring 36.

The opposite end 52 of the compression spring 36 rests on a ring-shaped profile disc 56 surrounding the nut tube 20. The profile disc 56 has a profile 58 complementary to the supported end 52 of the compression spring 36 to compensate for the perpendicularly cut wire end 52. The profile 58 of the profile disc 56 is shaped like or similar to the profile of the radial collar 42.

An inner housing tube 60 is friction-locked to the profile disc 56. The inner housing tube 60 protects the compression spring 36 and parts located in the telescoping portion 30 from contamination. During expansion and contraction of the power strut 10, the inner housing tube 60 glides inside the outer housing tube 16 along the longitudinal axis 32.

While the spring guide tube 38 may be non-rotatably fixed, the profile disc 56 may be rotatable relative to the outer housing tube 16 by torsional forces exerted by the compression spring 36. In general, at least one of the spring guide tube 38 and the profile disc 56 is preferably rotatable because of torsional movements of the ends 50 and 52 of the compression spring 36 during expansion and contraction of the compression spring 36.

Now referring to FIG. 3, the spindle nut 34, which bears the inner thread meshing with the outer thread of the drive spindle 28, is molded from plastic onto the motor-side end of the nut tube 20. The nut tube 20 is preferably made of metal, e.g. aluminum, and includes holes or other structural features 62 near the end to fixedly secure the overmolded spindle nut 34 to the nut tube 20 in a non-rotatable manner.

With the spindle nut 34 as well as the spring guide tube 38 being formed of plastic, the interface 64 between the spindle nut 34 and the spring guide tube 38 may have a fluted design to allow the spindle nut 34 to glide inside the spring guide tube 38 along the longitudinal axis 32, while providing an anti-rotation feature that prevents the spindle nut 34 from rotating with the drive spindle 28 relative to the spring guide tube 38.

Alternatively, an anti-rotation feature may be incorporated between the outer housing tube 16 and the inner housing tube 60. In that case, the inner housing tube 60 is secured against rotation relative to the spring-side joint socket 14, for example by heat-bonding or via an adhesive or by any other suitable technique.

Now referring to FIGS. 4a, 4b, and 4c, the drawings show steps of attaching the nut tube 20 to the spring-side joint socket 14. The end plug 18 has a radially extending disc-shaped circular rim 66 with a first cylindrical extension 68 to one axial side of the rim 66 and a second cylindrical extension 70 to the opposite side of the circular rim 66. The first cylindrical extension 68 is shown to have a smaller diameter than the second cylindrical extension 70, but it is within the scope of the present invention that the first cylindrical extension 68 has a larger diameter than the second cylindrical extension 70. It is preferred that the diameters of the first cylindrical extension 68 and the second cylindrical extension 70 differ from one another for the purpose of eliminating the risk of an inadvertent erroneous assembly in a reversed orientation of the end plug 18.

The first cylindrical extension 68 is a barb with a serrated outer surface prior to assembly as best seen in FIG. 4a. For attaching the end plug 18 to the plastic body of the spring-side joint socket 14, the barb 68 may be heated prior to insertion into a cavity 72 of the spring-side joint socket 14. As evident from the cross-section of FIG. 1, the cavity 72 receiving the barb 68 may have circumferential ribs or other radial elevations 74 on a circumferential inner wall with spaces between the ribs or elevations 74 filled by the heated material of the barb 68. The end plug 18 is preferably made of metal so that the barb 68 may be heated with an induction-heated coil prior to the insertion into the cavity 72 of the spring-side joint socket 14.

The second cylindrical extension 70 has a smooth cylindrical outer surface with a plurality of voids 76, such as holes or indentations, that are axially and circumferentially spaced apart as best seen in FIG. 4b. The outer diameter of the second cylindrical extension 70 is fitted to an inner diameter of the nut tube 20. Upon insertion of the second cylindrical extension 70, the nut tube 20 is crimped onto the second cylindrical extension 70. The crimping process displaces material of the nut tube 20 into the voids 76 of the second cylindrical extension 70. The crimped assembly of the nut tube 20 and the second cylindrical extension 70 as shown in FIG. 4c provides axial and torsional constraint.

Now referring to FIGS. 5a and 5b, the motor-side joint socket 12 bears a first snap structure 80 that is complementary to a second snap structure 82 formed on the outer housing tube 16. FIG. 5a shows the motor-side joint socket 12 and the outer housing tube 16 in an assembled state. The drive unit housing 22 is also partially shown.

Adjacent to the socket portion for attaching the joint socket to the vehicle part, the motor-side joint socket 12 has a first axial portion 88 with a diameter greater than the diameter of the outer housing tube 16. The first axial portion 88 includes axial slots 84 forming the first snap structure 80 cooperating with axially protruding tongues 86 on the outer housing tube 16 that form the second snap structure 82 and that are dimensioned to be inserted into the axial slots 84 on the first axial portion 88. The first and second snap structures 80 and 82 thus secure the motor-side joint socket 12 non-rotatably to the outer housing tube 16. As shown, the first axial portion 88 may be generally circular to cover the entire cross-section of the outer housing tube 16.

A second axial portion 90 has a cross-section adapted to fit inside the internal circumference 44 of the outer housing tube 16. The second axial portion 90 is preferably circular and has a radial annular groove 94 on its circumference that carries an O-ring 96 that has an outer circumference slightly exceeding the internal circumference 44 of the outer housing tube 16. In the assembled state as shown in FIG. 5a, the O-ring 96 is radially compressed between the second axial portion 90 and the internal circumference 44 of the outer housing tube 16. A third axial portion 92 projects into an end of the drive unit housing 22. The third axial portion 92 may have radial indentations or projections that prevent a relative rotation between the drive unit housing 22 and the motor-side joint socket 12.

The power strut 10 as described is composed mostly of plastic parts. The outer housing tube 16, the inner housing tube 60, the spring guide tube 38, the profile disc 56, and the spindle nut 34 consist of plastic. Even the drive unit housing 22, the spring-side joint socket 14 as well as the motor-side joint socket 12 may be made of plastic. The joint sockets 12 and 14 may be reinforced with metal in a few locations, for example in areas of high wear.

The foregoing description of various aspects of the invention has been presented for purposes of illustration and description. It is not intended to be exhaustive or to limit the invention to the precise aspects disclosed. Numerous modifications or variations are possible in light of the above teachings. The aspects discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A power strut for raising and lowering a panel of an automotive vehicle, comprising:
an outer housing tube having a first end carrying a first attachment element for attaching the power strut to a first vehicle part;
a spindle bearing an outer thread and being rotatable relative to the outer housing tube via an electric motor, the spindle defining a longitudinal axis and being axially stationary relative to the outer housing tube;
a spindle nut having an inner thread meshing with the outer thread of the spindle, the spindle nut being displaceable along the longitudinal axis relative to the spindle;
a nut tube rigidly connected to the spindle nut and surrounding at least a portion of the spindle;
a second attachment element for attaching the power strut to a second vehicle part; and
a compression spring surrounding the nut tube, the compression spring biasing the first and second attachment elements apart from each other, wherein the compression spring is an open spring formed of a coiled wire with perpendicularly cut wire ends.

2. The power strut of claim 1, further comprising a profile disc in contact with a first end of the compression spring, the profile disc being ring-shaped and surrounding the nut tube, the profile disc having a profile complementary to the first end of the compression spring to compensate for one of the perpendicularly cut wire ends.

3. The power strut of claim 2, wherein the profile disc is rotatable relative to the outer housing tube by torsional forces exerted by the compression spring.

4. The power strut of claim 2, further comprising a spring guide tube with a radial collar in contact with a second end of the compression spring, the spring guide tube extending between the compression spring and the nut tube, wherein the radial collar has a profile complementary to the second end of the compression spring.

5. The power strut of claim 4, wherein the spring guide tube is secured against rotation relative to the outer housing tube.

6. The power strut of claim 5, wherein the spring guide tube has an internal cross-sectional shape cooperating with an anti-rotation shape formed on the spindle nut the cross-sectional shape and the anti-rotation shape allowing the spindle nut to slide axially along the spring guide tube while maintaining a relative rotational position between the spindle nut and the spring guide tube.

7. The power strut of claim 4, wherein the radial end collar has a circumference with a radial annular groove and an O-ring disposed in the annular groove.

8. The power strut of claim 4, wherein the O-ring has an outer circumference bearing against an inner surface of the outer housing tube.

9. The power strut of claim 1, wherein the first attachment element has a first snap structure formed thereon that is complementary to a second snap structure formed on the outer housing tube, the first and second snap structures non-rotatably securing the first attachment element to the outer housing tube.

10. The power strut of claim 9, wherein the first snap structure consists of plastic.

11. The power strut of claim 9, wherein the outer housing tube consists of plastic, wherein one of the first and second snap structures is formed by snap tongues, wherein the other one of the first and second snap structures is formed by slots, and wherein the snap tongues are snapped into the slots.

12. The power strut of claim 11, wherein the slots are the first snap structure and the tongues are the second snap structure.

13. The power strut of claim 1, further comprising an O-ring disposed between the first attachment element and the outer housing tube, the O-ring being disposed in a radial annular groove formed along an outer circumference of the first attachment element.

14. The power strut of claim 1, wherein the second attachment element includes an end plug rigidly connected to the nut tube by crimping.

15. The power strut of claim 14, wherein the end plug has a cylindrical axial extension with a cylindrical surface having radial voids, the cylindrical axial extension being disposed inside the nut tube, wherein material of the nut tube is displaced radially inward into the voids.

16. The power strut of claim 15, wherein the second attachment element further includes a joint socket with a plastic body and wherein the end plug further has a serrated axial extension, the serrated axial extension being disposed inside the plastic body of the joint socket and rigidly connected therewith.

17. The power strut of claim 1, further comprising the electric motor and a planetary gear box arranged to translate a rotational output speed of the motor to a rotational drive speed of the spindle, wherein both the electric motor and the planetary gear box are disposed inside the outer housing tube.

18. The power strut of claim 1, further comprising an inner housing tube telescopically displaceably arranged radially inside the outer housing tube and surrounding the spindle nut, the spindle tube, and at least a portion of a compression spring biasing the first and second attachment elements apart from each other.

19. The power strut of claim 18, further including a spring guide tube arranged radially between the nut tube and the compression spring, wherein the outer housing tube, the inner housing tube, and the spring guide tube are made of plastic and the nut tube is made of metal.
